(19) United States
(12) Patent Application Publication
(10) Pub. No.: US 2023/0115249 A1
(43) Pub. Date: Apr. 13, 2023

(54) LOCALLY DIRECTED FILTERED AIR ENVIRONMENT APPARATUS

(71) Applicant: BOYU WANG, ROSEVILLE, CA (US)

(72) Inventor: BOYU WANG, ROSEVILLE, CA (US)

(21) Appl. No.: 17/962,493

(22) Filed: Oct. 8, 2022

Related U.S. Application Data
(60) Provisional application No. 63/262,293, filed on Oct. 8, 2021.

(51) Int. Cl. A62B 7/10; A62B 9/04

(52) U.S. Cl. CPC A62B 7/10; A62B 9/04

(57) ABSTRACT

An apparatus and method for providing a filtered air environment and streams of filtered air both in front of a wearer’s face at an angle to prevent contamination by pathogens and contaminants also supply filtered air to the nostrils and mouth, which also dilute any remaining particles. The device includes a blower element configured to direct a filtered airflow across a wearer’s face at an angle to push particles away and another stream of air to lead toward the nostrils and mouth to supply filtered air. The apparatus includes a fan or multiple fan elements to develop an airflow. A filter removes contaminants from the airflow and local environment of the wearer. Variations of a vent system have an intake conduit positioned close to the exhaust conduit, with or without an air deflector, to create a “microcirculation” that helps to capture the wearer’s exhaled particles and increases the filtration process.

### PRIORITY CLAIM

This application claims the benefit of priority to provisional application number 63/262,293 titled “Locally Directed Filtered Air Environment Apparatus,” filed on Oct. 8, 2021.

### BACKGROUND OF THE INVENTION

The present invention relates to personal protective equipment, and more particularly, to personal protective breathing equipment.

Protective face masks are vital in fighting against viral infections because they don’t need to be reworked whenever a new viral strain emerges. They can reduce the viral load on wearers, thus fewer symptoms. However, most protective face masks are uncomfortable to wear, especially for a long duration, and are not highly effective in preventing viral infection. Likewise, protective face masks are generally limited to covering the mouth and nostrils. Wearers can’t eat while wearing protective masks or allow observers to see the wearer’s facial expression and lips. People are unprotected from getting viral infections when eating in a group and without wearing protective devices. People who are deaf cannot read others’ lips for communication when others are masked. People are not used to forming relationships while wearing masks to cover parts of the face that are important for recognition and communication. Most people, especially kids, lack the discipline to wear masks continuously in public spaces such as classrooms, movies, cars, or airplanes. Most people may find it difficult to breathe while doing strenuous activities while wearing a mask. Also, a separate face shield or eyewear, such as protective glasses and goggles, may be required to protect against possible contamination through the eyes.

Powered air-purifying respirators (PAPR) have been utilized to deliver purified air within a mask covering the wearer’s face. However, these systems are incredibly costly, require extensive training, and must be regularly cleaned and maintained to ensure proper performance. Accordingly, these systems have limited distribution and are generally limited to HAZMAT response crews, infectious disease labs and wards, and other high-risk environments.

As can be seen, there is a need for an improved apparatus that is simple in construction and provides protection for pathogen pathways of the face, including the eyes, nostrils, and mouth. And increase in the wearer’s compliance to use the device due to added comfort and ability to carry out everyday activities of daily living without having to remove the device.

In addition, such an improved apparatus may also be applied similarly to animals, such as dogs.

### SUMMARY OF THE INVENTION

The present invention is a locally directed filtered air environment apparatus. The a locally directed filtered air environment apparatus includes an air filter apparatus attached to a head mount apparatus. The air filter apparatus includes an air filter device having an air filter housing, a fan housing, an air filter element contained in the air filter housing, and a fan element contained in the fan housing. Air way passages are provided in the air filter apparatus to direct the intake and exhaust of the air filter device. Generally, the exhaust of the air filter device directs filtered air over a person’s nose and mouth to both push away contaminant particles, as well as supply filtered air to wearer’s airway.

In an alternative embodiment of the present invention, the air filter device is positioned in front of a person’s nose by adjusting the head mount apparatus. The air way passages of the air filter device are an air filter intake and an air filter exhaust with an opening of each positioned a distance from each other to induce a localized microcirculation. The air filter exhausts create an air curtain and the air filter intake intakes a portion of the filtered air from said air filter exhaust to induce the localized microcirculation. The volumetric flow rate of the air filter exhaust is greater than the volumetric flow rate of the air filter intake and the volumetric flow rate of the air filter intake is configured to be adjustable.

In another alternative embodiment of the present invention, the air filter device further includes an air deflector having a transparent air reflector body with a nose cushion. The air deflector aids in directing the filtered air exiting air filter device towards the nose and mouth of the person and aids in the intake of a persons exhaled breath. The air deflector further aids in creating a more direct air curtain across the persons nose and mouth and induces a stronger localized microcirculation.

In yet another alternative embodiment of the present invention, the air filter device includes an air circulator with a transparent air circulator body and a lip and with an air circulator intake and an air circulator exhaust formed into the air circulator body. The air circulator is attached to the air filter device and the air circulator intake is connected with the air filter intake and the air circulator exhaust is aligned with the air filter exhaust. An opening of the air circulator intake and the air circulator exhaust are each positioned a distance from each other to induce a localized microcirculation. The air circulator exhausts create an air curtain and the air circulator intake intakes a portion of the filtered air from the air circulator exhaust to induce the localized microcirculation. The volumetric flow rate of the air circulator exhaust is greater than the volumetric flow rate of the air circulator intake and the volumetric flow rate of the air circulator intake is configured to be adjustable.

### BRIEF DESCRIPTION OF THE DRAWINGS

FIG. 1 is a perspective view of a locally directed filtered air environment apparatus in use.

FIG. 2 is a perspective view of the locally directed filtered air environment apparatus in use.

FIG. 3 is an exploded view of the locally directed filtered air environment apparatus in use.

FIG. 4 is a section view of the locally directed filtered air environment apparatus in use, taken along line 4-4 in FIG. 2.

FIG. 5 is a section view of the locally directed filtered air environment apparatus in use.

FIG. 6 is a perspective view of a first alternate embodiment of a locally directed filtered air environment apparatus in use.

FIG. 7 is a perspective view of a second alternate embodiment of the locally directed filtered air environment apparatus in use.

FIG. 8 is a perspective view of alternate use of the locally directed filtered air environment apparatus in use.

FIG. 9 is a perspective view of a third alternate embodiment of the locally directed filtered air environment apparatus in use.

FIG. 10 is a perspective view of the third alternate embodiment of the locally directed filtered air environment apparatus in use.

FIG. 11 is an exploded view of the third alternate embodiment of the locally directed filtered air environment apparatus in use.

FIG. 12 is a section view of the third alternate embodiment of the locally directed filtered air environment apparatus in use, taken along line 12-12 in FIG. 10.

FIG. 13 is a section view of the third alternate embodiment of the locally directed filtered air environment apparatus in use.

FIG. 14 is a perspective view of a fourth alternate embodiment of a locally directed filtered air environment apparatus in use.

FIG. 15 is a top front perspective view of an air filter apparatus of the fourth alternate embodiment of the locally directed filtered air environment apparatus.

FIG. 16 is a top-back perspective view of the air filter apparatus of the fourth alternate embodiment of a locally directed filtered air environment apparatus.

FIG. 17 is a top view of the air filter apparatus of the fourth alternate embodiment of a locally directed filtered air environment apparatus.

FIG. 18 is a bottom view of the air filter apparatus of the fourth alternate embodiment of a locally directed filtered air environment apparatus.

FIG. 19 is a section view of the air filter apparatus of the fourth alternate embodiment of a locally directed filtered air environment apparatus, taken along line 19-19 in FIG. 15.

FIG. 20 is a section view of the air filter apparatus of the fourth alternate embodiment of a locally directed filtered air environment apparatus, taken along line 20-20 in FIG. 16.

FIG. 21 is a right-side view of the fourth alternate embodiment of a locally directed filtered air environment apparatus in use.

FIG. 22-A is a close-up view of the nose and mouth of the user with the fourth alternate embodiment of a locally directed filtered air environment apparatus in use taken along circle 22 of FIG. 21, showing the user exhaling.

FIG. 22-B is a close-up view of the nose and mouth of the user with the fourth alternate embodiment of a locally directed filtered air environment apparatus in use taken along circle 22 of FIG. 21, showing the user inhaling.

FIG. 23 is a top front perspective view of an air filter apparatus of a fifth alternate embodiment of the locally directed filtered air environment apparatus.

FIG. 24 is a top-back perspective view of the air filter apparatus of the fifth alternate embodiment of a locally directed filtered air environment apparatus.

FIG. 25 is a top view of the air filter apparatus of the fifth alternate embodiment of a locally directed filtered air environment apparatus.

FIG. 26 is a bottom view of the air filter apparatus of the fifth alternate embodiment of a locally directed filtered air environment apparatus.

FIG. 27 is a section view of the air filter apparatus of the fifth alternate embodiment of a locally directed filtered air environment apparatus, taken along line 27-27 in FIG. 23.

FIG. 28 is a section view of the air filter apparatus of the fifth alternate embodiment of a locally directed filtered air environment apparatus, taken along line 28-28 in FIG. 24.

FIG. 29 is a right-side view of the fifth alternate embodiment of a locally directed filtered air environment apparatus in use.

FIG. 30-A is a close-up view of the nose and mouth of the user with the fifth alternate embodiment of a locally directed filtered air environment apparatus in use taken along circle 30 of FIG. 29, showing the wearer inhaling.

FIG. 30-B is a close-up view of the nose and mouth of the user with the fifth alternate embodiment of a locally directed filtered air environment apparatus in use taken along circle 22 of FIG. 21, showing the wearer exhaling.

FIG. 31 is a top-back perspective view of the air filter apparatus of the fifth alternate embodiment of a locally directed filtered air environment apparatus with showing movements of more horizontal air currents.

FIG. 32 is a top-back perspective view of the air filter apparatus of the fifth alternate embodiment of a locally directed filtered air environment apparatus with showing movements of more vertical or diagonal air currents.

### DETAILED DESCRIPTION OF THE INVENTION

The following detailed description is of the best currently contemplated modes of carrying out exemplary embodiments of the invention. The description is not to be taken in a limiting sense but is made merely to illustrate the general principles of the invention.

Broadly, embodiments of the present invention provide a locally directed filtered air environment apparatus and method for providing a filtered air environment locally to a wearer’s face. The device includes a blower element configured to control a filtered airflow across a wearer’s face, especially eyes, nostrils, and mouth. The filtered airflow provides air streams to ward off the infiltration of contaminants into the wearer’s mucus membranes in the mouth, nostrils, and eyes. The apparatus is a lightweight, convenient device that is easy to operate and requires minimal special training and maintenance.

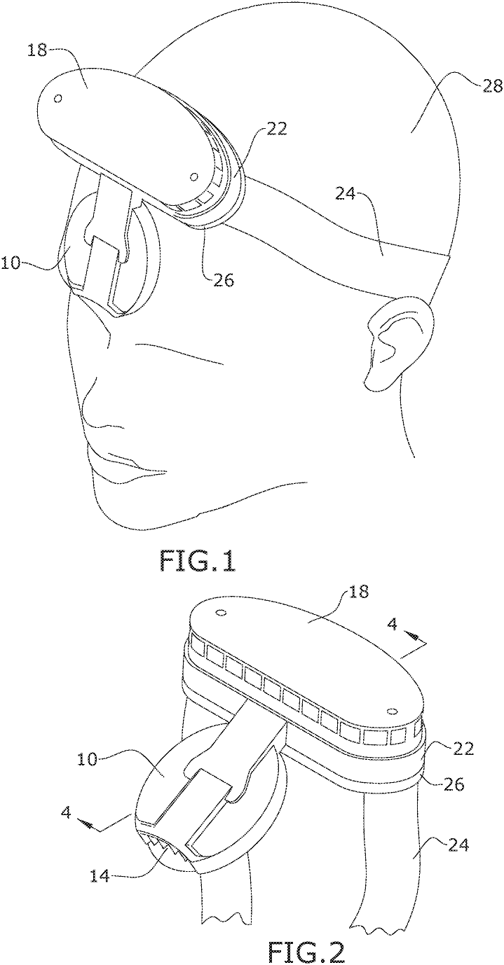

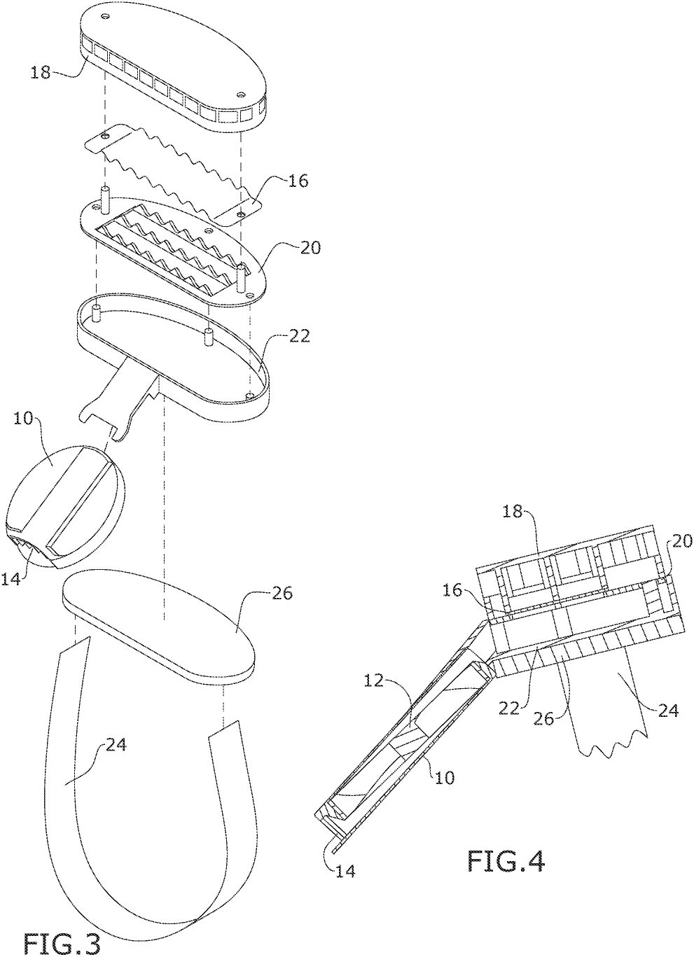

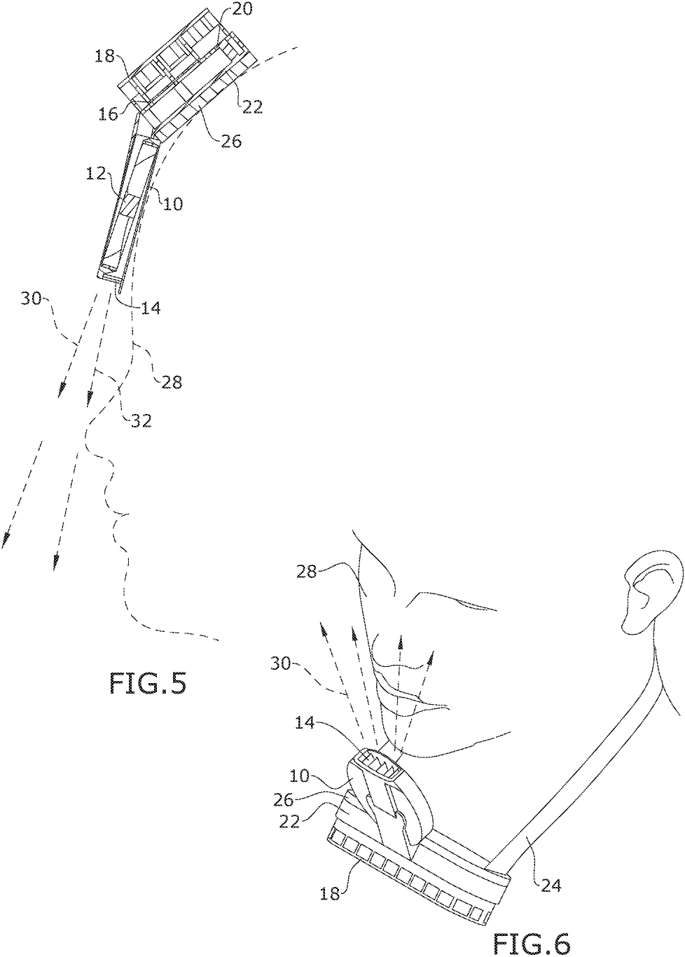

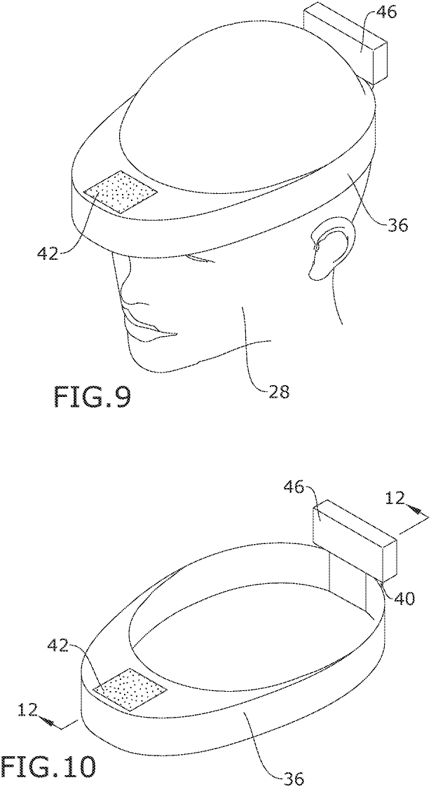

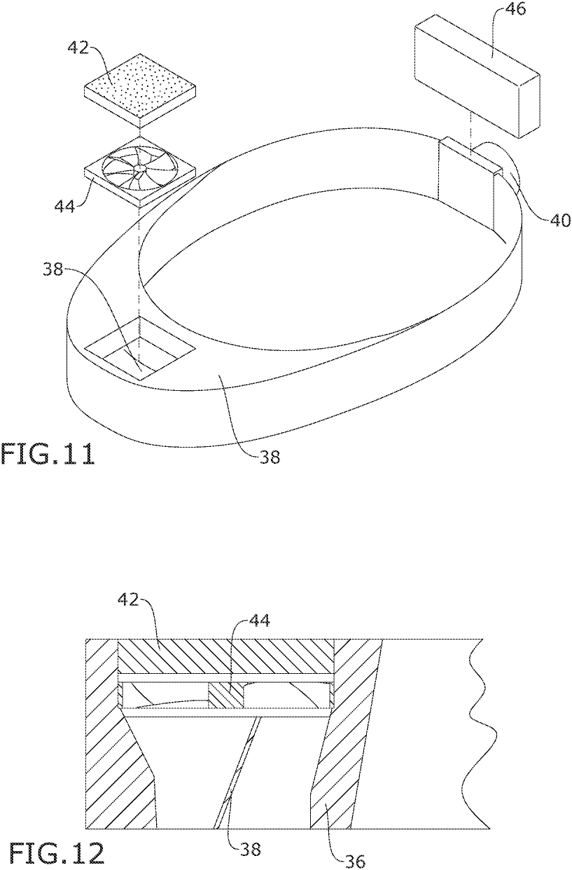

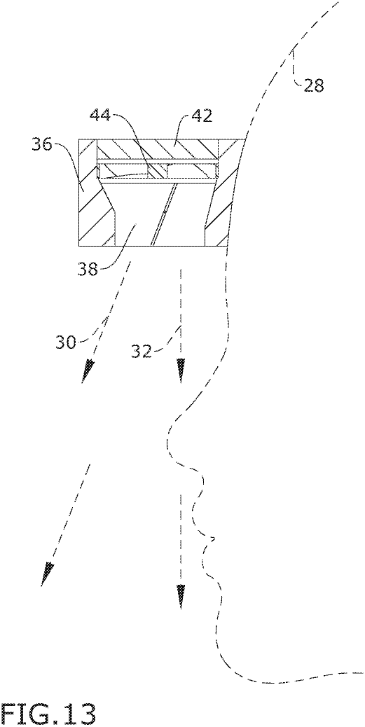

As seen in the drawings of FIGS. 1-13, the present apparatus invention includes a fan housing 10 containing a fan element 12 operable to develop an airflow. The airflow is carried through a flow conduit 14, which is configured to disperse the airflow in a splayed pattern to form streams of filtered air environment 30 - 32 in front of the user’s 28 face that both pushes away the contaminant particles, as well as supply of filtered air to wearer’s airway (the user 28 may also be referred to as wearer and person).

The locally directed filtered air environment apparatus includes a filter housing containing a filter 16 selected to provide airflow filtration. The filter 16 is chosen to filter contaminants based on a prospective threat. The filter is carried within a housing, which may include an upper filter housing 18 and a lower filter housing 22. In the non-limiting embodiment shown, a filter holder 20 may be provided to hold the filter 16 within the filter housing. In some embodiments, the filter 16 may be dimensioned to occupy all or a portion of the filter housing, depending on the selected filtration media and the type of contaminant.

The fan housing 10 and the filter housing may be carried by an item of headwear worn by the user 28. In the non-limiting embodiment shown, a headband 24 is provided to hold the fan housing 10 and the filter housing on the user’s head 28. The fan housing 10 and the filter housing may be employed as separate components or may be formed as a unitary component.

A power source, such as a battery 26, may be carried with one or more of the fan housing 10, the filter housing (the upper filter housing 18 and the lower filter housing 22), or the headband 24. The power source may also be carried externally of the device, such as by a battery pack carried by the wearer 28.

As in reference to FIGS. 5 and 6, the device may be worn with the filtered air streams 30-32 with a downward orientation. The device may also be worn with the filtered air streams 30-32 when the strap 24 is worn about a circumferential aspect atop the wearer’s head 28. It may also be oriented with an upward orientation by suspending the air barrier face shield with the strap 24 worn about the wearer’s neck 28. As seen in reference to FIG. 8, the device may also be placed on a support surface, such as a table or desk, where the user 28 may be seated to perform work tasks.

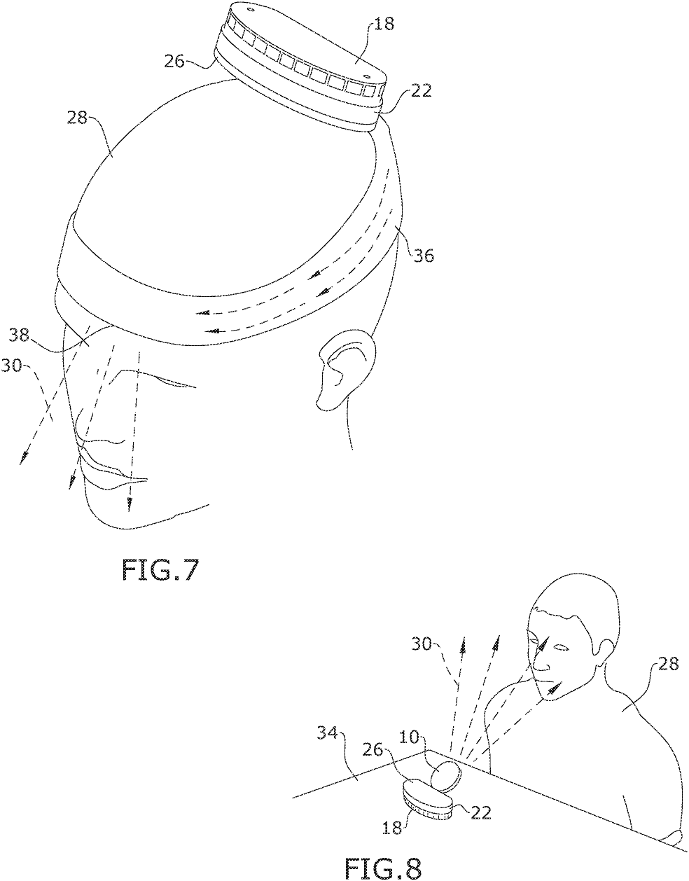

In the embodiment shown in FIG. 7 The fan housing 10 and filter housing may be carried on the back of the wearer’s head 28. In this case, the headband 24 may have an airflow conduit 36 defined with the headband 24. The filtered airflow may be directed out a dispersal vent 38 carried at the front end of the headband to develop the filtered streams of air 30 in front of the wearer’s face 28.

In another embodiment, the filter 42 and fan 44 are carried within a visor-type headgear worn on the user’s head. The battery pack 46 may be carried on an aft end of the headgear. In this embodiment, the airflow is drawn through the filter 42 by the fan 44. A dispersal vent 38 is formed within the visor to expel the filtered airflow as the filtered air streams.

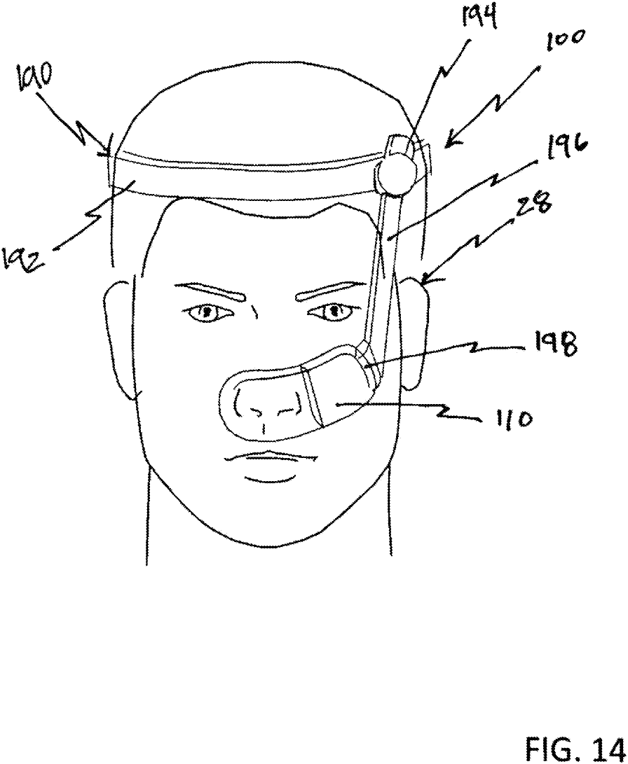

Referring now to FIG. 14, a fourth alternate embodiment of a locally directed filtered air environment apparatus is shown in use and designated 100. The locally directed filtered air environment apparatus 100 includes an air filter apparatus 110 and a head mount apparatus 190 attached to the air filter apparatus 110. The head mount apparatus 190 is worn by the person 28 and positions the air filter apparatus 110 in front of the nose and adjacent to the mouth, with the air filter apparatus 110 covering the nose while keeping the mouth free of obstructions. It is contemplated that a power source for the locally directed filtered air environment apparatus 100 is located on the head mount apparatus 190 to minimize the weight of the air filter apparatus 110.

The air filter apparatus 110 can intake the wearer’s 28 exhalation in conjunction with the air from the environment. The air is then filtered by the air filter apparatus 110 and exhausted at an angle towards the person’s 28 nose and mouth. The directed filtered air also forms an air curtain to prevent any unfiltered air from contacting the nose and mouth of the wearer and to keep the exhausted air from the person 28 from escaping beyond the curtain so the air filter apparatus 110 can intake and filter the exhausted air. This provides the filtering of the wearer’s 28 exhalation to remove any possible particles exhaled by the wearer while also delivering filtered air to the person 28 and preventing unfiltered air from contacting the nose and mouth.

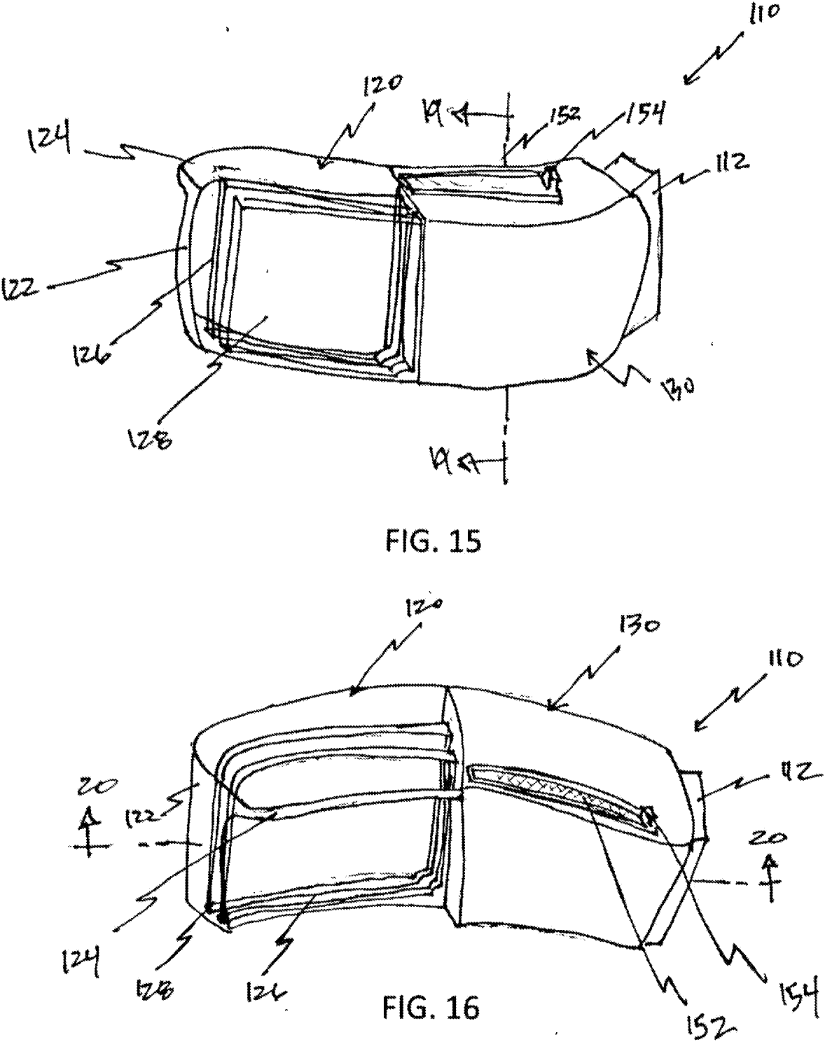

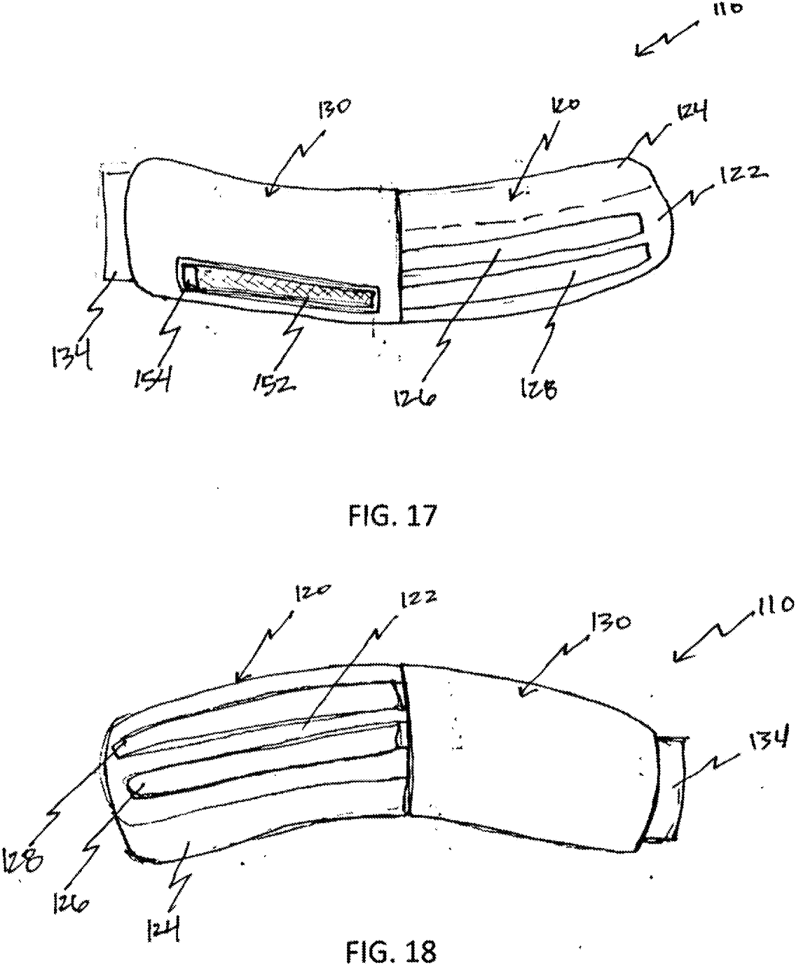

The air filter apparatus 110 is described in conjunction with FIGS. 15-20, includes an air circulator 120 attached to an air filter device 130. The air circulator 120 includes an air circulator body 122 with a lip 124. Formed into the air circulator body, 122 is an air circulator intake 126 and an air circulator exhaust 128. The air circulator 120 is made from a material that is preferably transparent but may be opaque. The transparency of the air circulator 120 portion of the air filter apparatus 110 allows the nose and parts of the mouth to be visible through the air circulator 120. This will enable people who are deaf and rely on lip reading to continue doing so when wearing the locally directed filtered air environment apparatus 100. However, the person 28 will have to be cognizant of adjusting the locally directed filtered air environment apparatus 100 when speaking with a person reliant on lip reading, especially with an opaque air circulator 120. The head mount apparatus 190 can be adjusted to move the air filter apparatus 110 away from the lips of the person 28.

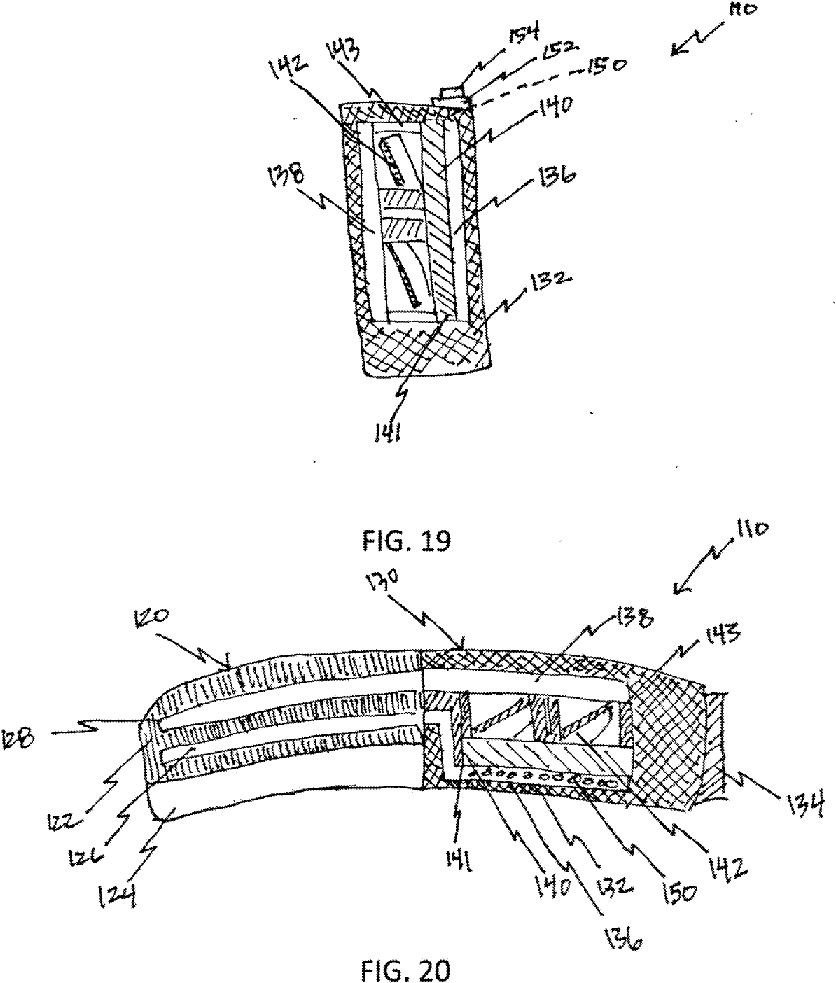

The air filter device 130 includes an air filter body 132 formed with an air filter housing 141 and a fan housing 143. An air filter element 140 is contained in the air filter housing, and a fan element 142 is contained in the fan housing 143. The fan element 142 is an axial fan, however it is contemplated that a radial fan may be used. Adjacent to the filter housing 141 is the air filter intake 136, and adjacent to the fan housing 143, opposite the air filter intake 136, is the air filter exhaust 138. The air filter intake 136 and the air filter exhaust 138 are on the same surface of the air filter body 132. Formed into the body 132 through the top are a plurality of intake vents 150 (shown in dashed lines in FIG. 19) that are connected to the air filter intake 136. The air filter intake 136 and the air filter exhaust 138 of the air filter device 130 line up with the air circulator intake 126 and the air circulator exhaust 128 of the air circulator 120, respectively, to create an intake and exhaust conduit. An intake baffle housing 152 and intake baffle 154 cover the intake vents 150 and may be adjusted to regulate airflow into the intake vents 150. Attached to the side of the air filter device 130 is an air filter apparatus mount 134.

The air filter apparatus 110 is pivotally attached to the head mount apparatus 190 through the air filter apparatus mount 134. The head mount apparatus 190 includes a head mount apparatus connector 198 attached to one end of an extension arm 196. The extension arm 196 is slidably received and coupled to an adjustable pivot mount 194, which is attached to an adjustable headband 192. The head mount apparatus connector 198 is attached to the air filter apparatus mount 134 and provides a pivot point. The extension arm 196 can slide up and down the adjustable pivot mount 194, while the adjustable pivot mount 194 allows the arm to rotate. The multiple points of rotation and extension of the various components of the head mount apparatus 190 provide the proper articulation of positioning the air filter apparatus 110 at its optimal location on the person 28.

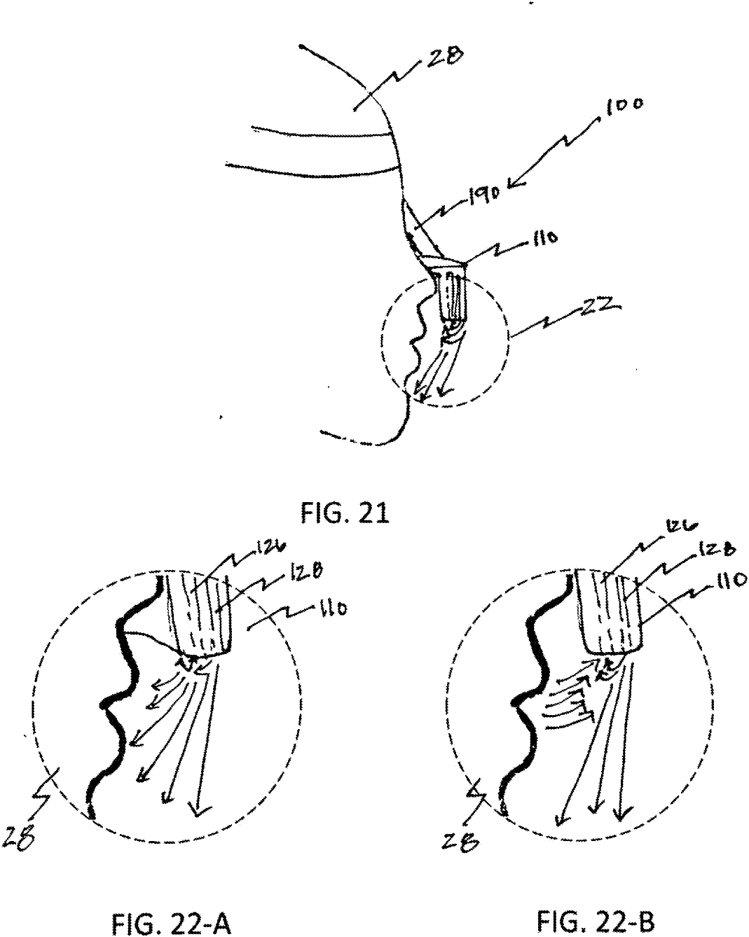

As seen in FIG. 21, the person 28 is wearing the locally directed filtered air environment apparatus 100. It has positioned the air filter apparatus 110 in its optimal position about the face of the person 28 by adjusting the head mount apparatus 190. The air filter apparatus 110 is pressed against the face of the person 28, wherein the lip 124 is above the nose and in contact with the bridge of the nose, and the air filter apparatus 110 follows the curvature of the face to minimize air leakage. By positioning the air filter apparatus 110 as close to the person’s 28 nose and mouth, the head loss due to ducting is minimized allowing the air filter apparatus 110 to utilize a less powerful fan element 142 to draw in air.

When powered on, fan element 142 pulls air in through the intake vents 150 and the intake conduit (the air circulator intake 126 and the air filter intake 136) through the air filter element 140. It exhausts the filtered air through the exhaust conduit (the air circulator exhaust 136 and the air filter exhaust 137). Unfiltered air from the environment enters through the intake vents 150, and exhaled air from the person 28 penetrates through the intake conduit (the air circulator intake 126 and the air filter intake 136). The unfiltered air is filtered through the filter element 140 and is directed towards the nose and mouth of the person 28 to deliver filtered air for the person 28 to breathe and help push away an unfiltered air away from the face, which in turn creates an air curtain over the nose and mouth of the person 28.

The proximity of an opening of the intake conduit (the air circulator intake 126 and the air filter intake 136) and an opening of the exhaust conduit (the air circulator exhaust 136 and the air filter exhaust 137) to each other promotes and induces the creation of microcirculation. By positioning the intake conduit (the air circulator intake 126 and the air filter intake 136) below the nose and closer to the exhaust conduit (the air circulator exhaust 136 and the air filter exhaust 137), it ensures that air from the air outlet will be pulled into the air intake creating a circular air stream; exhaled air will be drawn into the circular air stream and be circulated (the microcirculation). Due to the addition of the intake vents 150, the volume flow rate at the air circulator intake 126 is lower than the volume flow rate at the air circulator exhaust 136. This ensures that more filtered air is delivered to the person 28 than is pulled in by the air filter apparatus 110.

The flow rate of the filtered air exiting the air circulator exhaust 136 is high enough to ensure an air curtain is created and will not be compromised by the inhalation by the person or the intake of air at the air circulator intake 126 by the air filter apparatus 110. The flow rate of the filtered air exiting is also high enough where a portion of the filtered air will also be directed all across the air filter device 110 including the air circulator body 122 with the lip 124, which prevents any unfiltered air from reaching the nose and mouth. Additionally, the flow rate of the air at the air circulator intake 126 is high enough to intake all of a portion of the wearer’s exhalation 28. Any exhalation not pulled in by the air intake device 110 will be pulled by the air curtain and dispersed into the environment.

The difference in the volume flow rate between the air circulator intake 126 and the volume flow rate at the air circulator exhaust 136 should be a minimum of the average respiration volume flow rate of a normal human, which is between 5-8 liters per minute when the wearer is at rest and minimum of 56 liters per minute when the wearer is exercising. To adjust for the volumetric flow rate of the intake of air by the air filter apparatus 110, the intake baffle 154 may be adjusted to regulate the flow of air into the intake vents 150 and via the voltage sent to the fan element that can be adjusted via the current state-of-the-art circuitry.

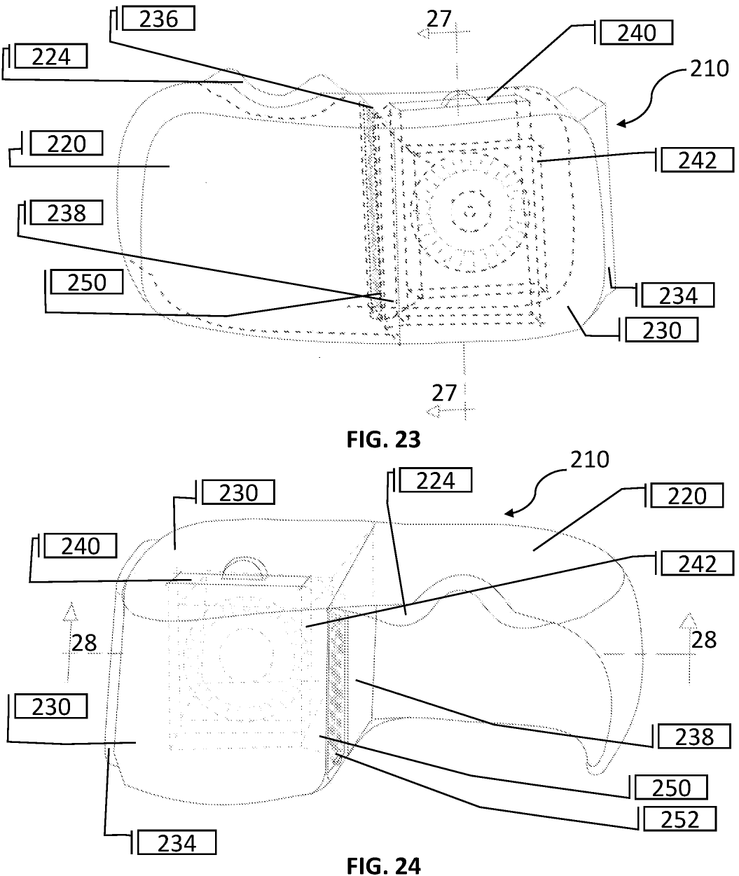

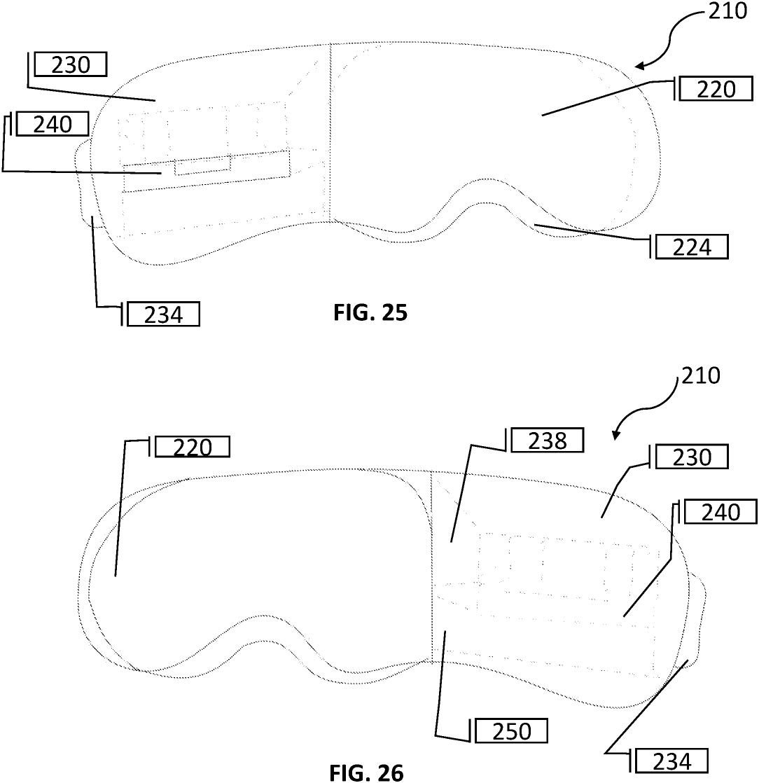

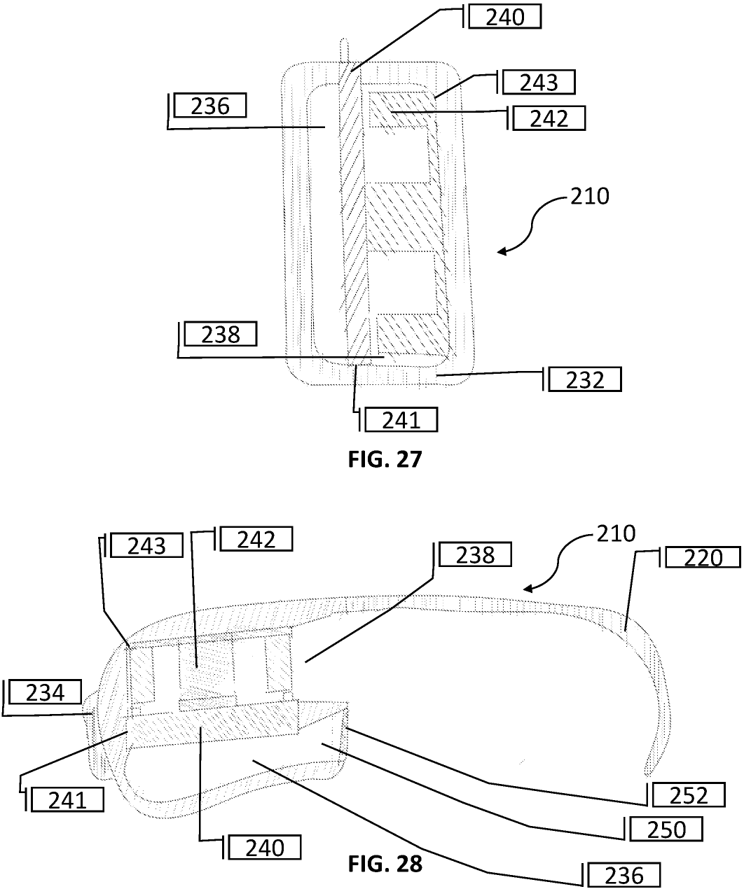

A fifth alternate embodiment of the locally directed filtered air environment apparatus is shown in FIG. 23 and is designated 200. A second variation of an air filter apparatus 210, described in conjunction with FIGS. 24-28, includes an air deflector 220 attached to an air filter device 230. The second variation of the air filter apparatus 210 provides all the benefits of the air filter apparatus 110. The air deflector 220 includes an air reflector body 222 with a nose cushion 224. The air deflector 220 is made from a material that is preferably transparent but may be opaque. The transparency of the air deflector 220 and portions of the air filter apparatus 210 allows the nose and parts of the mouth to be visible through the air deflector 220. This will enable people who are deaf and rely on lip reading to continue doing so when wearing the locally directed filtered air environment apparatus 200. However, the person 28 will have to be cognizant of adjusting the locally directed filtered air environment apparatus 200 with an opaque air deflector 220 when speaking with a person reliant on lip reading.

The air filter device 230 includes an air filter body 232 formed with an air filter housing 241 and a fan housing 243. An air filter element 240 is contained in the air filter housing, and a fan element 242 is included in the fan housing 243. The fan element 242 is a radial fan, however it is contemplated that an axial fan may be used. Adjacent to the filter housing 241 is the air filter intake 236 and adjacent to the fan housing 243, opposite the air filter intake 236, is the air filter exhaust 238. The air filter intake 236 and the air filter exhaust 238 are on the same surface of the air filter body 232. Formed into the body 232 is intake vent 250 (FIG. 24), which is connected to the air filter intake 236. An intake cover 252 helps to filter out larger debris and moisture. Attached to the side of the air filter device 230 is an air filter apparatus mount 234. The second variation of the air filter apparatus 210 is pivotally attached to the head mount apparatus 190 through the air filter apparatus mount 234.

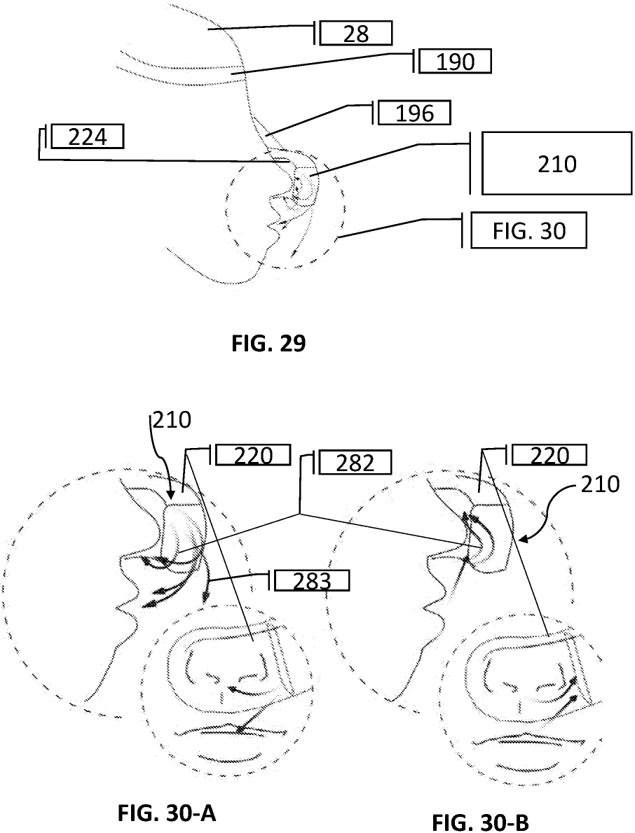

As seen in FIG. 29, the person 28 is wearing the locally directed filtered air environment apparatus 200 and has positioned the second variation of the air filter apparatus 210 in its optimal position about the face of the person 28 by adjusting the head mount apparatus 190. The second variation of the air filter apparatus 210 is pressed against the face of the person 28, wherein nose cushion 224 is above the nose and in contact with the bridge of the nose, and the curvature of the second variation of the air filter apparatus 210 follows the curvature of the face to minimize air leakage.

When powered on, fan element 242 pulls air in through the intake vents 250 through the air filter element 240 and exhausts the filtered air through the exhaust 238. Unfiltered air from the environment enters through the intake vents 250, and exhaled air from the wearer 28 penetrates through the intake conduit (air filter intake 236). The unfiltered air is filtered through the filter element 240 and is directed towards the nose and mouth of the person 28 to deliver filtered air for the person 28 to breathe and help push away an unfiltered air away from the face, which in turn creates an air curtain over the nose and mouth of the person 28. The air deflector 220 aids in directing the filtered air exiting to the exhaust conduit 238 towards the nose and mouth of the person 28.

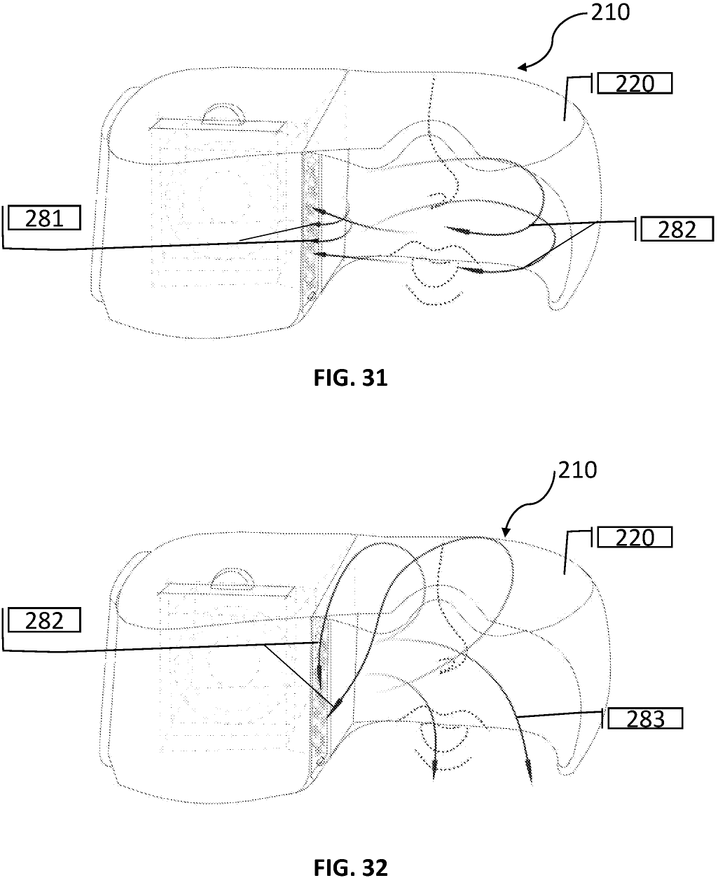

The proximity of the intake conduit 250 and the exhaust conduit 238 to each other promotes the creation of microcirculation (arrow 281, FIG. 31). Positioning the intake conduit 250 next to the nose and or mouth of the person 28 and closer to the exhaust conduit 238 ensures that a portion of air from the exhaust conduit 238 will be pulled into the intake conduit 250 creating a circular air stream; exhaled air will be drawn into the circular air stream and be circulated (arrow 282, FIGS. 30-31-32); air deflector 220 also guides the exhaust air current to nose and mouth then back to the intake conduit 250; the exhaust air current also joins exhaled air from the airway back to intake conduit 250; it guides exhaust air that exits the air filter apparatus 210 to create an air curtain right in front of the mouth as well as supply filtered air toward the mouth (arrow 283); air deflector 220 helps to guide exhaled air from nose and mouth to flow to the intake conduit 250; it also acts as a physical barrier to any large particles, solid or liquid, from reaching the wearer’s airway and the intake conduit 250.

It should be understood, of course, that the foregoing relates to exemplary embodiments of the invention and that modifications may be made without departing from the spirit and scope of the invention as set forth herein.

I claim:

1. A locally directed filtered air environment apparatus comprising:
a head mount apparatus configured to be worn by a person;
an air filter apparatus having an air filter device, the air filter apparatus is attached to the head mount apparatus and configured to filter air; and
wherein the head mount apparatus is worn on a person’s head and the air filter apparatus is positioned in front of a person’s nose and mouth for the air filter apparatus to filter unfiltered air and deliver filtered air to the person’s mouth and nose.

2. The air filter device of claim 1 comprising:
an air filter body having an air filter intake configured to intake unfiltered air and an air filter exhaust positioned a distance from the air filter intake and configured to exhaust filtered air.

3. The air filter device of claim 2 wherein the air filter exhaust exhausts air to create an air curtain and the air filter intake intakes a portion of the filtered air from the air filter exhaust inducing a localized micro-air circulation.

4. The air filter device of claim 3 further comprising a means to adjust the volumetric flow rate of the air filter intake.

5. The air filter device of claim 4 wherein the volumetric flow rate of the air filter exhaust is greater than the volumetric flow rate of the air filter intake by at least 5 liters per minute.

6. A locally directed filtered air environment apparatus comprising:
an air filter apparatus connected to a head mount apparatus configured to be worn by a person;
the air filter apparatus having an air filter device comprising
an air filter body formed with an air filter intake adjacent an air filter housing, a fan housing adjacent to the air filter housing, and an air filter exhaust adjacent to the fan housing,
an air filter element contained in the air filter housing, and
a fan element contained in the fan housing;
wherein the head mount apparatus is worn on a person’s head and the air filter apparatus is positioned in front of a person’s nose and mouth for the air filter apparatus to filter unfiltered air and deliver filtered air to the person’s mouth and nose.

7. The air filter device of claim 6 wherein the air filter exhaust is positioned a distance apart from the air filter intake on the same side of the air filter body.

8. The air filter device of claim 7 wherein the air filter exhaust exhausts air to create an air curtain and the air filter intake intakes a portion of the filtered air from the air filter exhaust inducing a localized microcirculation of air.

9. The air filter device of claim 7 further comprising a means to adjust the volumetric flow rate of the air filter intake.

10. The air filter device of claim 7 wherein the volumetric flow rate of the air filter exhaust is greater than the volumetric flow rate of the air filter intake by at least 5 liters per minute.

11. A locally directed filtered air environment apparatus comprising:
a head mount apparatus having an adjustable headband;
an air filter apparatus comprising an air filter device having
an air filter body formed with an air filter intake adjacent an air filter housing, a fan housing adjacent to the air filter housing, and an air filter exhaust adjacent to the fan housing,
an air filter element contained in the air filter housing, and
a fan element contained in the fan housing;
wherein the adjustable head band of the head mount apparatus is worn on a person’s head and the air filter apparatus is attached to the adjustable head band and positioned in front of a person’s nose and mouth for the air filter apparatus to filter unfiltered air and deliver filtered air to the person’s mouth and nose.

12. The air filter apparatus of claim 11 further comprising an air circulator having a transparent air circulator body with a lip and with an air circulator intake and an air circulator exhaust formed into the air circulator body, wherein the air circulator is attached to the air filter device and the air circulator intake is aligned with the air filter intake and the air circulator exhaust is aligned with the air filter exhaust.

13. The air filter device of claim 12 wherein an opening of the air circulator intake is positioned a distance apart from an opening of the air circulator exhaust on the same side of the air circulator body.

14. The air filter device of claim 13 wherein the air filter exhaust exhausts air to create an air curtain and the air filter intake intakes a portion of the filtered air from the air filter exhaust inducing a localized microcirculation of air.

15. The air filter device of claim 14 further comprising a means to adjust the volumetric flow rate of the air filter intake and the volumetric flow rate of the air circulator exhaust is greater than the volumetric flow rate of the air circulator intake by at least 5 liters per minute.

16. The air filter apparatus of claim 11 further comprising an air deflector having a transparent air reflector body with a nose cushion.

17. The air filter device of claim 16 wherein an opening of the air filter exhaust is positioned a distance apart from an opening of the air filter intake on the same side of the air filter body.

18. The air filter device of claim 17 wherein the air filter exhaust exhausts air to create an air curtain and the air filter intake intakes a portion of the filtered air from the air filter exhaust inducing a localized microcirculation of air.

19. The air filter device of claim 17 further comprising a means to adjust the volumetric flow rate of the air filter intake.

20. The air filter device of claim 17 wherein the volumetric flow rate of the air filter exhaust is greater than the volumetric flow rate of the air filter intake by at least 5 liters per minute.
